(19) United States
(12) Patent Application Publication
(10) Pub. No.: US 2015/0358635 A1
(43) Pub. Date: Dec. 10, 2015

(54) MOTION INFORMATION SIGNALING FOR SCALABLE VIDEO CODING

(71) Applicant: Vid Scale, Inc., Wilmington, DE (US)

(72) Inventors: Xiaoyu Xiu, San Diego, CA (US); Yong He, San Diego, CA (US); Yuwen He, San Diego, CA (US); Yan Ye, San Diego, CA (US)

(73) Assignee: VID SCALE, INC., Wilmington, DE (US)

(21) Appl. No.: 14/759,428

(22) PCT Filed: Jan. 7, 2014
(86) PCT No.: PCT/US2014/010479

§ 371 Date: Jul. 7, 2015

Related U.S. Application Data
(60) Provisional application No. 61/749,688, filed on Jan. 7, 2013.
(60) Provisional application No. 61/754,245, filed on Jan. 18, 2013.

(51) Int. Cl. H04N 19/51; H04N 19/44; H04N 19/172

(52) U.S. Cl. CPC H04N 19/51; H04N 19/172; H04N 19/44

(57) ABSTRACT

Systems, methods and instrumentalities are provided to implement motion information signaling for scalable video coding. A video coding device may generate a video bitstream comprising a plurality of base layer pictures and a plurality of corresponding enhancement layer pictures. The video coding device may identify a prediction unit (PU) of one of the enhancement layer pictures. The video coding device may determine whether the PU uses an inter-layer reference picture of the enhancement layer picture as a reference picture. The video coding device may set motion vector information associated with the inter-layer reference picture of enhancement layer to a value indicative of zero motion, e.g., if the PU uses the inter-layer reference layer picture as the reference picture.

### CROSS REFERENCE TO RELATED APPLICATIONS

This application claims the benefit of U.S. Provisional Patent Application Nos. 61/749,688 filed on Jan. 7, 2013, and 61/754,245 filed on Jan. 18, 2013, the contents of which are hereby incorporated by reference herein.

### BACKGROUND

With the availability of high bandwidths on wireless networks, multimedia technology and mobile communications have experienced massive growth and commercial success in recent years. Wireless communications technology has dramatically increased the wireless bandwidth and improved the quality of service for mobile users. Various digital video compression and/or video coding technologies have been developed to enable efficient digital video communication, distribution and consumption. Various video coding mechanisms may be provided to improve coding efficiencies. For example, in case of motion compensated prediction based on collocated inter-layer reference picture, motion vector information may be provided.

### SUMMARY OF THE INVENTION

Systems, methods and instrumentalities are provided to implement motion information signaling for scalable video coding. A video encoding device (VED) may generate a video bitstream comprising a plurality of base layer pictures and a plurality of corresponding enhancement layer pictures. The base layer pictures may be associated with a base layer bitstream, and the enhancement layer pictures may be associated with the enhancement layer bitstream. The VED may identify a prediction unit (PU) of one of the enhancement layer pictures. The VED may determine whether the PU uses an inter-layer reference picture of the enhancement layer picture as a reference picture. The VED may set motion vector information associated with the inter-layer reference picture of enhancement layer (e.g., motion vector predictor (MVP), motion vector difference (MVD), etc.) to a value indicative of zero motion. e.g., if the PU uses the inter-layer reference picture as a reference picture for motion prediction. The motion vector information may comprise one or more motion vectors. The motion vectors may be associated with the PU.

The VED may disable the use of the inter-layer reference picture for bi-prediction of the PU of the enhancement layer picture, e.g., if the PU uses the inter-layer reference picture as the reference picture. The VED may enable bi-prediction of the PU of the enhancement layer picture, e.g., if the PU performs motion compensated prediction from the inter-layer reference picture and temporal prediction. The VED may disable the use of the inter-layer reference picture for bi-prediction of the PU of the enhancement layer picture, e.g., if the PU uses the inter-layer reference picture as the reference picture.

A video decoding device (VDD) may receive a video bitstream comprising a plurality of base layer pictures and a plurality of enhanced layer pictures. The VDD may set an enhancement layer motion vector associated with the PU to a value indicative of zero motion, e.g., if a PU of the one of the enhancement layer pictures makes reference to an inter-layer reference picture as a reference picture for motion prediction.

### BRIEF DESCRIPTION OF THE DRAWINGS

A more detailed understanding may be had from the following description, given by way of example in conjunction with the accompanying drawings.

FIG. 1 is a diagram illustrating an example of scalable structure with additional inter-layer prediction for scalable video coding (SVC).

FIG. 2 is a diagram illustrating an example of scalable structure with additional inter-layer prediction for high efficiency video coding (HEVC) spatial scalable coding.

FIG. 3 is a diagram illustrating an example of an architecture of a 2-layer scalable video encoder.

FIG. 4 is a diagram illustrating an example of an architecture of a 2-layer scalable video decoder.

FIG. 5 is a diagram illustrating an example of a block-based single layer video encoder.

FIG. 6A is a diagram illustrating an example of a block-based single layer video decoder.

FIG. 6B is a diagram illustrating an example of video encoding method.

FIG. 6C is a diagram illustrating an example of video decoding method.

FIG. 7A is a system diagram of an example communications system in which one or more disclosed embodiments may be implemented.

FIG. 7B is a system diagram of an example wireless transmit/receive unit (WTRU) that may be used within the communications system illustrated in FIG. 7A.

FIG. 7C is a system diagram of an example radio access network and an example core network that may be used within the communications system illustrated in FIG. 7A.

FIG. 7D is a system diagram of another example radio access network and another example core network that may be used within the communications system illustrated in FIG. 7A.

FIG. 7E is a system diagram of another example radio access network and another example core network that may be used within the communications system illustrated in FIG. 7A.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application.

Widely deployed commercial digital video compression standards are developed by the International Organization for Standardization/International Electrotechnical Commission (ISO/IEC) and ITU Telecommunication Standardization Sector (ITU-T), for example, Moving Picture Experts Group-2 (MPEG-2), and H.264 (MPEG-4 Part 10). Due to the emergence and maturity of advanced video compression technologies, High Efficiency Video Coding (HEVC) is under joint development by ITU-T Video Coding Experts Group (VCEG) and MPEG.

Video applications such as video chat, mobile video, and streaming video, compared with traditional digital video services over satellite, cable, and terrestrial transmission channels, may be employed that may be heterogeneous on the client and/or the network side. Devices such as smart phone, tablet, and TV are expected to dominate the client side, where video may be transmitted across the Internet, the mobile network, and/or a combination of both. To improve the user experience and video quality of service, scalable video coding (SVC) may be used. SVC may encode the signal at a highest resolution. SVC may enable decoding from subsets of the streams depending on the specific rate and resolution that may be required by a certain application and supported by the client device. International video standards, for example, MPEG-2 Video, H.263, MPEG4 Visual, and H.264, may provide tools and/or profiles to support various scalability modes.

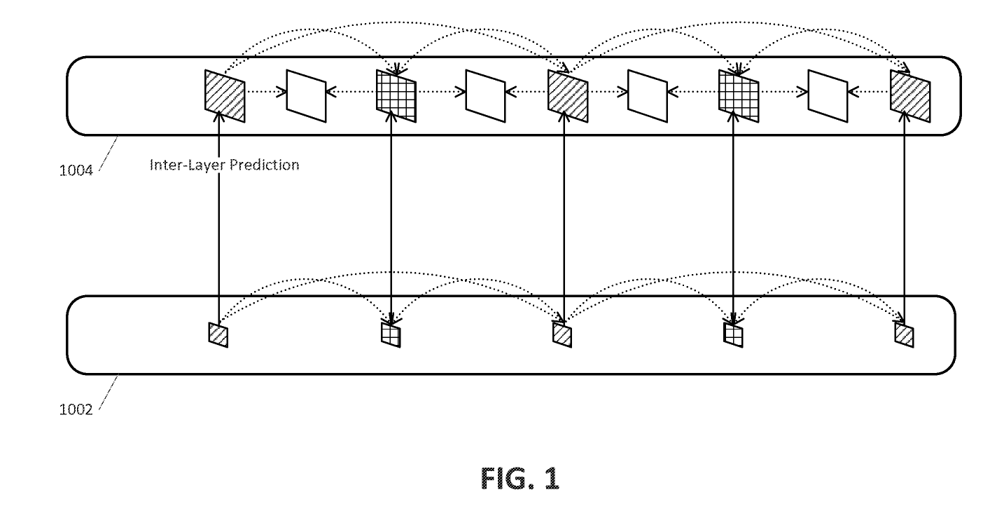

The scalability extension of, for example, H.264 may enable the transmission and decoding of partial bit streams to provide video services with lower temporal, spatial resolutions and/or reduced fidelity, while retaining a reconstruction quality that may be high relative to the rate of the partial bit streams. FIG. 1 is a diagram illustrating an example of a two layer SVC inter-layer prediction mechanism to improve scalable coding efficiency. A similar mechanism may be applied to multiple layer SVC coding structures. As illustrated in FIG. 1, the base layer 1002 and the enhancement layer 1004 may represent two adjacent spatial scalable layers with different resolutions. The enhancement layer may be a layer higher (e.g., higher in resolution) than the base layer. Within each single layer, motion-compensated prediction and intra-prediction may be employed as standard H.264 encoder (e.g., as represented by dot lines in FIG. 1). Inter-layer prediction may use base layer information such as spatial texture, motion vector predictors, reference picture indices, residual signals, etc. The base layer information may be used to improve coding efficiency of the enhancement layer 1004. When decoding an enhancement layer 1004. SVC may not use reference pictures from lower layers (e.g., dependent layers of the current layer) to be fully reconstruct enhancement layer pictures.

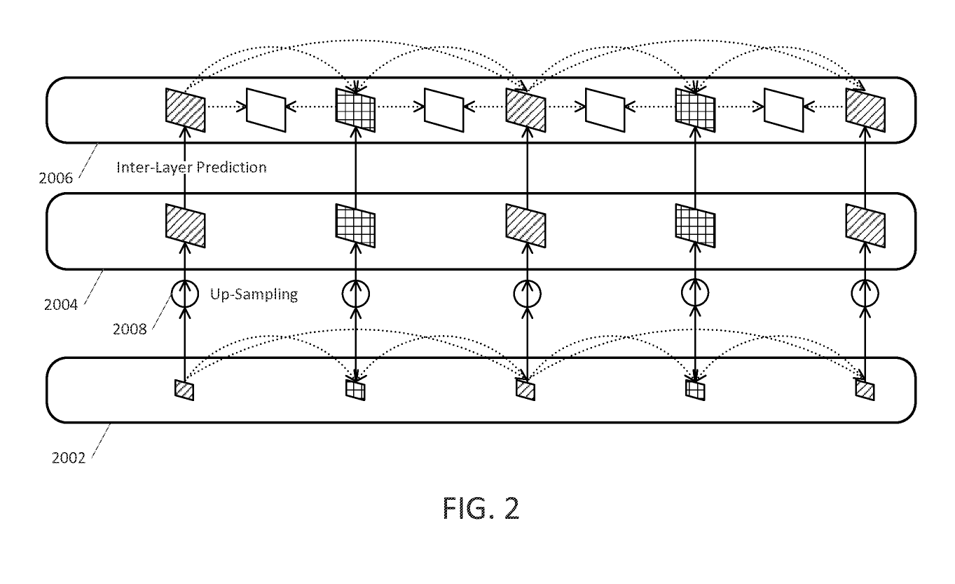

Inter-layer prediction may be employed in HEVC scalable coding extension, e.g., to explore the strong correlation among multiple layers, and to improve scalable coding efficiency. FIG. 2 is a diagram illustrating an example of an inter-layer prediction structure for HEVC scalable coding. As illustrated in FIG. 2, prediction of an enhancement layer 2006 may be formed by motion-compensated prediction from a reconstructed base layer signal 2004 (e.g., after up-sampling the base layer signal 2002 at 2008, if the spatial resolutions between the two layers are different). The prediction of the enhancement layer 2006 may be formed by temporal prediction within the current enhancement layer and/or by averaging a base layer reconstruction signal with a temporal prediction signal. Such prediction may require reconstruction (e.g., full reconstruction) of the lower layer pictures as compared with H.264 SVC (e.g., as described in FIG. 1). The same mechanism may be deployed for HEVC scalable coding with at least two layers. A base layer may be referred to as a reference layer.

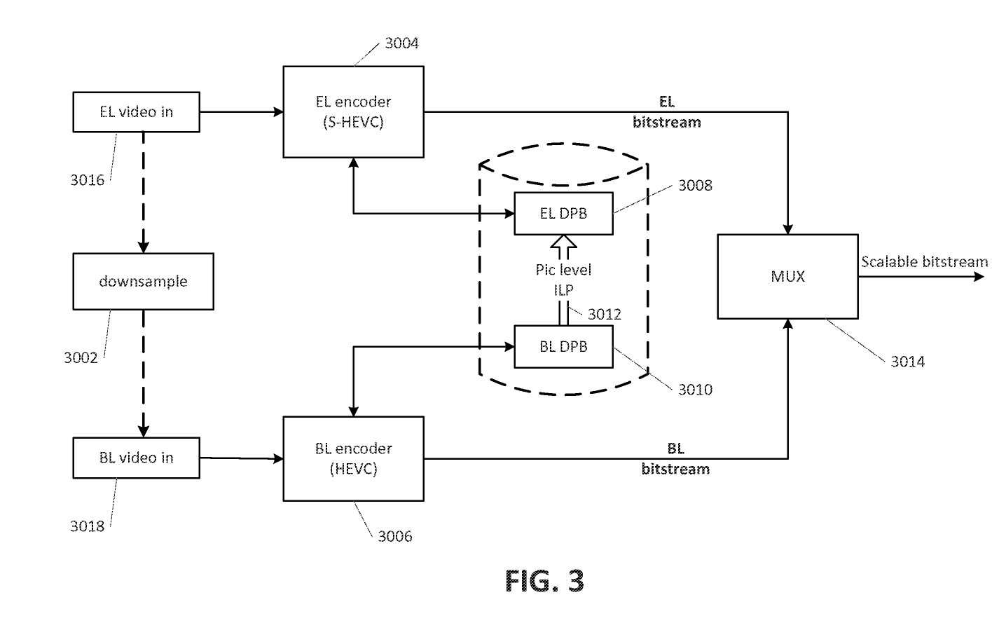

FIG. 3 is a diagram illustrating example architecture of a two-layer scalable video encoder. As illustrated in FIG. 3, an enhancement layer video input 3016 and the base layer video input 3018 may correspond to each other by the down-sampling process that may achieve spatial scalability. At 3002, the enhancement layer video 3016 may be down-sampled. The base layer encoder 3006 (e.g., an HEVC encoder) may encode the base layer video input block by block and generate a base layer bitstream. The enhancement layer, the enhancement layer (EL) encoder 3004 may take EL input video signal of higher spatial resolution (and/or higher values of other video parameters). The EL encoder 3004 may produce an EL bitstream in a substantially similar manner as the base layer video encoder 3006, e.g., utilizing spatial and/or temporal predictions to achieve compression. An additional form of prediction, referred to herein as inter-layer prediction (ILP) may be available at the enhancement encoder to improve its coding performance. As illustrated in FIG. 3, the base layer (BL) pictures and EL pictures may be stored in a BL decoded picture buffer (DPB) 3010 and an EL DPB 3008 respectively. Unlike spatial and temporal predictions that derive the prediction signal based on coded video signals in the current enhancement layer, inter-layer prediction may derive the prediction signal based on picture-level ILP 3012 using the base layer (and/or other lower layers when there are more than two layers in the scalable system). A bitstream multiplexer (e.g., the MUX 3014 in FIG. 3) may combine the base layer bitstream and the enhancement layer bitstream to produce one scalable bitstream.

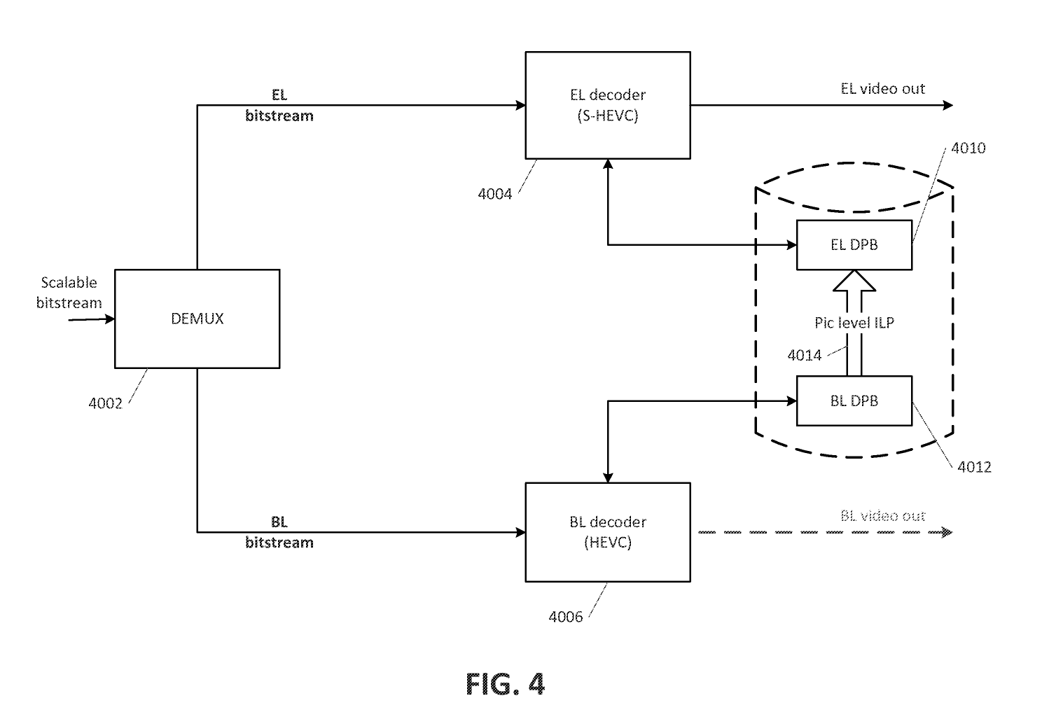

FIG. 4 is a diagram illustrating an example of a two-layer scalable video decoder that may correspond to the scalable encoder depicted in FIG. 3. The decoder may perform one or more operations, for example in a reverse order relative to the encoder. For example, the de-multiplexer (e.g., the DEMUX 4002) may separate the scalable bitstream into the base layer bitstream and the enhancement layer bitstream. The base layer decoder 4006 may decode the base layer bitstream and may reconstruct the base layer video. One or more of the base layer pictures may be stored in the BL DPB 4012. The enhancement layer decoder 4004 may decode the enhancement layer bitstream by using information from the current layer and/or information from one or more dependent layers (e.g., the base layer). For example, such information from one or more dependent layers may go through inter layer processing, which may be accomplished when picture-level ILP 4014 are used. One or more of the enhancement layer pictures may be stored in the EL DPB 4010. Though not shown in FIGS. 3 and 4, additional ILP information may be multiplexed together with base and enhancement layer bitstreams at the MUX 3014. The ILP information may be de-multiplexed by the DEMUX 4002.

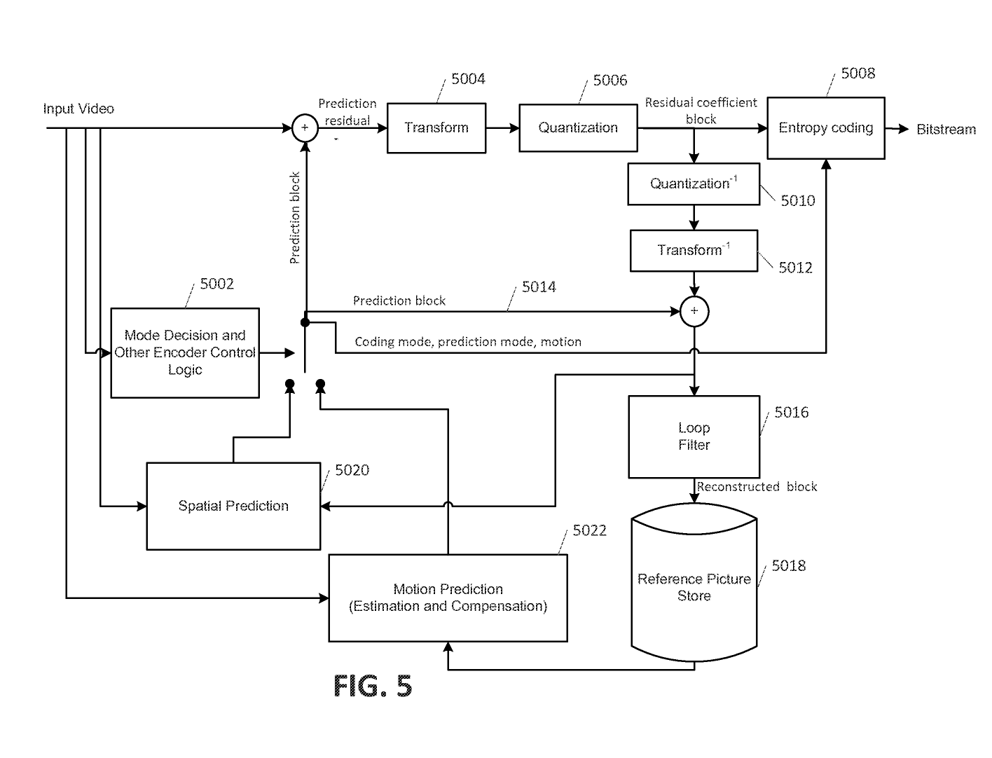

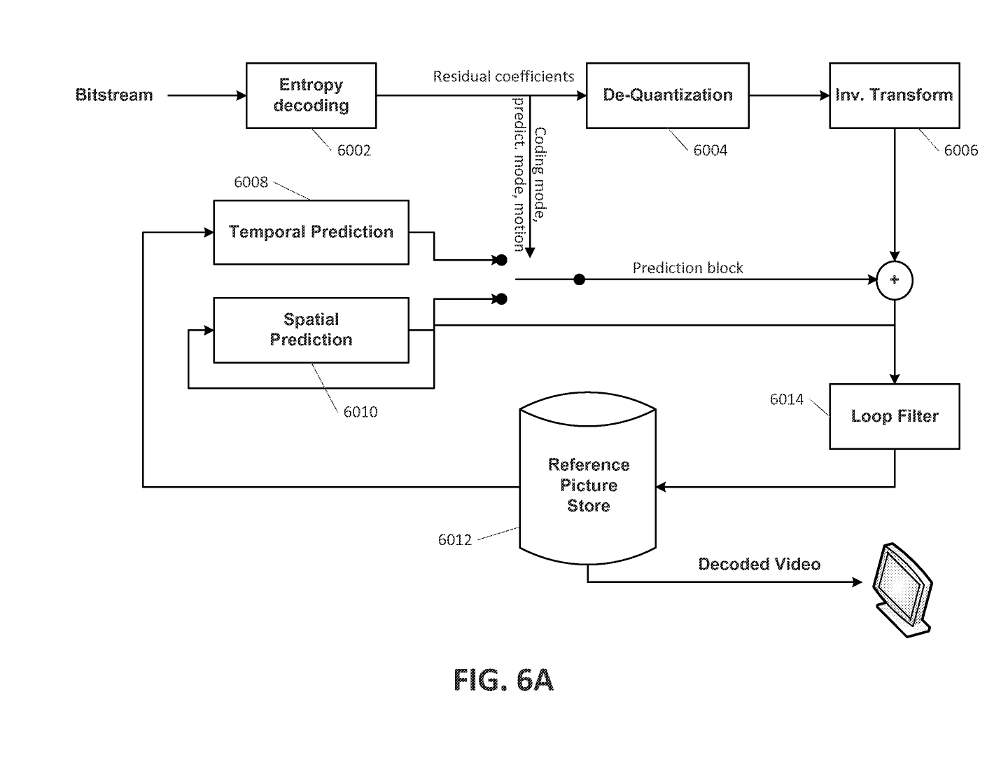

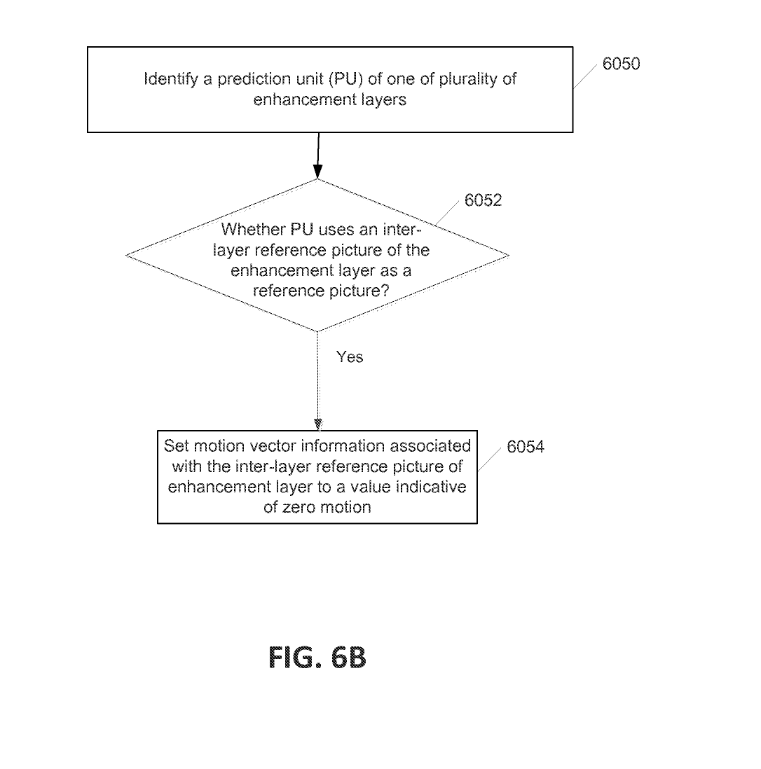

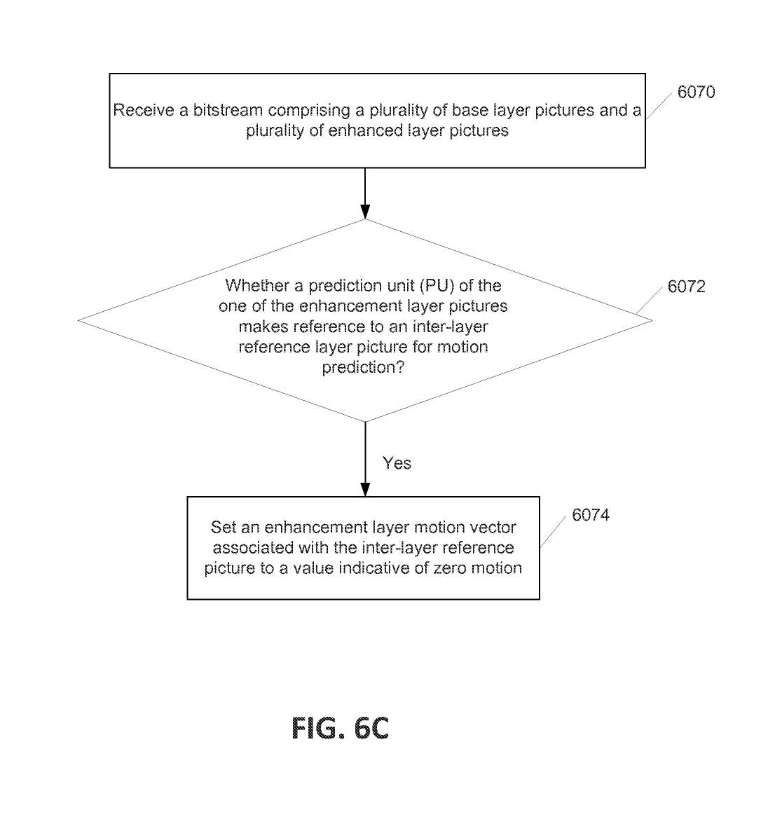

FIG. 5 is a diagram illustrating an example block-based single layer video encoder that may be used as the base layer encoder in FIG. 3. As illustrated in FIG. 5 a single layer encoder may employ techniques such as spatial prediction 5020 (e.g., referred to as intra prediction) and/or temporal prediction 5022 (e.g., referred to as inter prediction and/or motion compensated prediction) to achieve efficient compression, and/or predict the input video signal. The encoder may have mode decision logics 5002 that may choose the most suitable form of prediction. The encoder decision logics may be based on a combination of rate and distortion considerations. The encoder may transform and quantize the prediction residual (e.g., the difference signal between the input signal and the prediction signal) using the transform unit 5004 and quantization unit 5006 respectively. The quantized residual, together with the mode information (e.g., intra or inter prediction) and prediction information (e.g., motion vectors, reference picture indexes, intra prediction modes, etc.) may be further compressed at the entropy coder 5008 and packed into the output video bitstream. The encoder may generate the reconstructed video signal by applying inverse quantization (e.g., using inverse quantization unit 5010) and inverse transform (e.g., using inverse transform unit 5012) to the quantized residual to obtain reconstructed residual. The encoder may add the reconstructed video signal back to the prediction signal 5014. The reconstructed video signal may go through loop filter process 5016 (e.g., using deblocking filter, Sample Adaptive Offsets, and/or Adaptive Loop Filters), and may be stored in the reference picture store 5018 to be used to predict future video signals. The term reference picture store may be used interchangeably herein with the term decoded picture buffer or DPB. FIG. 6A is a diagram illustrating an example block-based single layer decoder that may receive a video bitstream produced by the encoder of FIG. 5 and may reconstruct the video signal to be displayed. At the video decoder, the bitstream may be parsed by the entropy decoder 6002. The residual coefficients may be inverse quantized (e.g., using the de-quantization unit 6004) and inverse transformed (e.g., using the inverse transform unit 6006) to obtain the reconstructed residual. The coding mode and prediction information may be used to obtain the prediction signal. This may be accomplished using spatial prediction 6010 and/or temporal prediction 6008. The prediction signal and the reconstructed residual may be added together to get the reconstructed video. The reconstructed video may additionally go through loop filtering (e.g., using loop filter 6014). The reconstructed video may then be stored in the reference picture store 6012 to be displayed and/or be used to decode future video signals.

HEVC may provide advanced motion compensated prediction techniques to explore inter-picture redundancy inherent in video signals by using pixels from already coded video pictures (e.g., reference pictures) to predict the pixels in a current video picture. In motion compensated prediction, the displacement between the current block to be coded and its one or more matching blocks in the reference pictures may be represented by a motion vector (MV). Each MV may comprise two components, MVx and MVy, representing the displacement in the horizontal and vertical directions, respectively. HEVC may further employ one or more picture/slice types for motion compensated prediction, e.g., the predictive picture/slice (P-picture/slice), bi-predictive picture/slice (B-picture/slice), etc. In the motion-compensated prediction of P-slice, uni-directional prediction (uni-prediction) may be applied where each block may be predicted using one motion-compensated block from one reference picture. In B-slice, in addition to the uni-prediction available in P-slice, bi-directional prediction (e.g., bi-prediction) may be used, where one block may be predicted by averaging two motion-compensated blocks from two reference pictures. To facilitate the management of reference pictures, in HEVC, a reference picture list may be specified as a list of reference pictures that may be used for motion compensated prediction of P- and B-slices. A picture list (e.g., LIST0) may be used in the motion compensated prediction of P-slice and reference picture lists (e.g., LIST0, LIST1, etc.) may be used for prediction of B-slice. To reconstruct the same predictor for motion compensated prediction during the decoding process, the reference picture list, reference picture index, and/or MVs may be sent to the decoder.

In HEVC, a prediction unit (PU) may include a basic block unit that may be used for carrying information related to motion prediction, including the selected reference picture list, the reference picture index, and/or MVs. Once a coding unit (CU) hierarchical tree is determined, each CU of the tree may be further split into multiple PUs. HEVC may support one or more PU partition shapes, where partitioning modes of, for example, 2N×2N, 2N×N, N×2N and N×N may indicate the split status of the CU. The CU, for example, may not be split (e.g., 2N×2N), or may be split into: two equal-size PUs horizontally (e.g., 2N×N), two equal-size PUs vertically (e.g., N×2N), and/or four equal-size PUs (e.g., N×N). HEVC may define various partitioning modes that may support splitting CU into PUs with difference sizes, for example, 2N×nU, 2N×nD, nL×2N and nR×2N, which may be referred to as asymmetric motion partitions.

A scalable system with two layers (e.g., a base layer, and an enhancement layer) using, for example, HEVC single-layer standard may be described herein. However, the mechanisms described herein may be applicable to other scalable coding systems using various types of underlying single-layer codecs, having at least two layers.

In a scalable video coding system, for example, as shown in FIG. 2, a default signaling method of HEVC may be used to signal motion-related information of each PU in the enhancement layer. Table 1 illustrates an exemplary PU signaling syntax.

TABLE 1

Descriptor

prediction_unit( x0, y0, nPbW, nPbH ) {

if( skip_flag[ x0 ][ y0 ] ) {

if( MaxNumMergeCand > 1 )

| | |
|---|---|
| merge_idx[ x0 ][ y0 ] | ae(v) |

} else { /* MODE_INTER */

| | |
|---|---|
| merge_flag[ x0 ][ y0 ] | ae(v) |
| if( merge_flag[ x0 ][ y0 ] ) { | |

if( MaxNumMergeCand > 1 )

| | |
|---|---|
| merge_idx[ x0 ][ y0 ] | ae(v) |

} else {

if( slice_type = = B )

| | |
|---|---|
| inter_pred_idc[ x0 ][ y0 ] | ae(v) |

if( inter_pred_idc[ x0 ][ y0 ] != Pred_L1 ) {

if( num_ref_idx_l0_active_minus1 > 0 )

| | |
|---|---|
| ref_idx_l0[ x0 ][ y0 ] | ae(v) |

| | |
|---|---|
| mvd_codling( x0, y0, 0 ) | |
| mvp_l0_flag[ x0 ][ y0] | ae(v) |

}
if( inter_pred_idc[ x0 ][ y0 ] != Pred_L0 ) {

if( num_ref_idx_l1_active_minus1 > 0 )

| | |
|---|---|
| ref_idx_l1[ x0 ][ y0 ] | ae(v) |

if( mvd_l1_zero_flag &&

inter_pred_idc[ x0 ][ y0 ] = = Pred_BI) {
MvdL1[ x0 ][ y0 ][ 0 ] = 0
MvdL1[ x0 ][ y0 ][ 1 ] = 0

} else

mvd_coding( x0, y0, 1 )

| | |
|---|---|
| mvp_l1_flag[ x0 ][ y0 ] | ae(v) |

}

}

}

}

Using the PU signaling of single-layer HEVC for scalable video coding, the inter-prediction of the enhancement layer may be formed by combining the signal of the inter-layer reference picture obtained from the base layer (for example, up-sampling if spatial resolutions are different between the layers) with that of another enhancement layer temporal reference picture. However, this combination may reduce the effectiveness of inter-layer prediction and therefore the coding efficiency of the enhancement layer. For example, applying up-sampling filters for spatial scalability may introduce ringing artifacts to the up-sampled inter-layer reference pictures, compared with the temporal enhancement layer reference pictures. A ringing artifact may result in higher prediction residuals which may be hard to quantize and coded. HEVC signaling design may allow averaging two prediction signals from the same inter-layer reference picture for bi-prediction of the enhancement layer. It may be more efficient to represent two prediction blocks that may come from one inter-layer reference picture by using one prediction block from the same inter-layer reference picture. For example, the inter-layer reference picture may be derived from a collocated base layer picture. There may be zero motion between the corresponding regions of the enhancement layer picture and the inter-layer reference picture. In some cases, the current HEVC PU signaling may allow the enhancement layer picture to use non-zero motion vectors, for example, when making reference to the inter-layer reference picture for motion prediction. The HEVC PU signaling may cause efficiency loss of motion compensated prediction in the enhancement layer. As shown in FIG. 2, an enhancement layer picture may refer to an inter-layer reference picture for motion compensated prediction.

In HEVC PU signaling for enhancement layer, the motion compensated prediction from the inter-layer reference picture may be combined with the temporal prediction within the current enhancement layer, or with the motion compensated prediction from the enhancement layer itself. The bi-prediction cases may reduce the efficiency of inter-layer prediction and may result in a performance loss of enhancement layer coding. Two uni-prediction constraints may be used to increase motion prediction efficiency when, for example, using an inter-layer reference picture as a reference.

The use of inter-layer reference pictures for bi-prediction of the enhancement layer pictures may be disabled. The enhancement layer picture may be predicted using uni-prediction, e.g., if a PU of the enhancement layer picture makes reference to the inter-layer reference picture for motion prediction.

Bi-prediction of the enhancement layer may be enabled to combine the motion compensated prediction from the inter-layer reference picture with the temporal prediction from the current enhancement layer. The prediction of the enhancement layer may be disabled to combine two motion compensated predictions that may come from the same inter-layer reference picture. The inter-layer uni-prediction constraints may comprise operational changes at the encoder side. The PU signaling, for example as provided in Table, 1 may remain unchanged.

The PU signaling method with zero MV constraint may simplify enhancement layer MV signaling when an inter-layer reference picture is selected as a reference for enhancement layer motion prediction. There may be no motion between the matching areas of the enhancement layer picture and its corresponding collocated inter-layer reference picture. This may reduce the overhead of explicitly identifying motion vector predictor (MVP) and motion vector difference (MVD). Zero MVs may be used, e.g., when an inter-layer reference picture is used for motion compensated prediction of an PU of the enhancement layer picture. The enhancement layer picture may be associated with the enhancement layer, and the inter-layer reference picture may be derived from a base layer picture (e.g., a collocated base layer picture). Table 2 illustrates an exemplary PU syntax with the inter-layer zero MV constraint. As illustrated in Table 2, the motion vectors information (e.g., indicated by variables MvdL0, and MvdL1) may be equal to zero, e.g., if a picture indicated by ref idx_10 or ref idx_11 corresponds to an inter-layer reference puncture. The motion vectors associated with the inter-layer reference picture may not be sent, e.g., when an inter-layer reference picture is used for motion compensated prediction of an PU of the enhancement layer picture.

TABLE 2

Descriptor

prediction_unit( x0, y0, nPbW, nPbH ) {

if( skip_flag[ x0 ][ y0 ] ) {

if( MaxNumMergeCand > 1 )

| | |
|---|---|
| merge_idx[ x0 ][ y0 ] | ae(v) |

} else { /* MODE_INTER */

| | |
|---|---|
| merge_flag[ x0 ][ y0 ] | ae(v) |
| if( merge_flag[ x0 ][ y0 ] ) { | |

if( MaxNumMergeCand > 1 )

| | |
|---|---|
| merge_idx[ x0 ][ y0 ] | ae(v) |

} else {

if( slice_type = = B )

| | |
|---|---|
| inter_pred_idc[ x0 ][ y0 ] | ae(v) |

if( inter_pred_idc[ x0 ][ y0 ] != Pred_L1 ) {

if( num_ref_idx_l0_active_minus1 > 0 )

| | |
|---|---|
| ref_idx_l0[ x0 ][ y0 ] | ae(v) |

if(zeroMV_enabled_flag && IsLRPic(L0, ref_idx_l0[x0][y0]){

```
  MvdL0[ x0 ][ y0 ][ 0 ] = 0
  MvdL0[ x0 ][ y0 ][ 1 ] = 0
```

}else

mvd_coding( x0, y0, 0 )

if(zeroMV_enabled_flag && IsILRPic(L0, ref_idx_l0[x0][y0]){

```
  MvpL0[ x0 ][ y0 ][ 0 ] = 0
  MvpL0[ x0 ][ y0 ][ 1 ] = 0
```

}else

| | |
|---|---|
| mvp_l0_flag[ x0 ][ y0 ] | ae(v) |

}
if( inter_pred_idc[ x0 ][ y0 ] != Pred_L0 ) {

if( num_ref_idx_l1_active_minus1 > 0 )

| | |
|---|---|
| ref_idx_l1[ x0 ][ y0 ] | ae(v) |

if( mvd_l1_zero_flag &&

inter_pred_idc[ x0 ][ y0 ] = = Pred_BI) {
MvdL1[ x0 ][ y0 ][ 0 ] = 0
MvdL1[ x0 ][ y0 ][ 1 ] = 0

} else{

if(zeroMV_enabled_flag && IsILRPic(L1,

ref_idx_l1[x0][y0]){

```
  MvdL1[ x0 ][ y0 ][ 0 ] = 0
  MvdL1[ x0 ][ y0 ][ 1 ] = 0
```

}else

mvd_coding( x0, y0, 1 )

```
  }
  if(zeroMV_enabled_flag && IsILRPic(L1, ref_idx_l1[x0][y0]){
```

```
  MvpL1[ x0 ][ y0 ][ 0 ] = 0
  MvpL1[ x0 ][ y0 ][ 1 ] = 0
```

}else

| | |
|---|---|
| mvp_l1_flag[ x0 ][ y0 ] | ae(v) |

}

}

}

}

As illustrated in Table 2, a flag, e.g., a zeroMV_enabled_flag may be used to specify whether the zero MV constraint may be applied to the enhancement layer when an inter-layer reference (ILR) picture is used as a reference. The zeroMV_enabled_flag may be signaled in a sequence level parameter set (e.g., a sequence level parameter set). The function IsILRPic(LX, refldx) may specify if the reference picture with reference picture index refldx from reference picture list LX is an inter-layer reference picture (TRUE) or not (FALSE).

The inter-layer zero MV constraint may be combined with the first inter-layer uni-prediction constraint for the motion compensated prediction of enhancement layer that may involve inter-layer reference picture as reference. The enhancement layer PU may be uni-predicted by using the pixels of the co-located block at the inter-layer reference picture for prediction, e.g., if one PU of the enhancement layer picture makes reference to the inter-layer reference picture.

The inter-layer zero MV constraint may be combined with the second inter-layer uni-prediction constraint for motion compensated prediction of the enhancement layer that may involve inter-layer reference picture as reference. For the motion prediction of each enhancement layer PU, prediction from the co-located block at the inter-layer reference picture may be combined with the temporal prediction from the enhancement layer.

The use of a zero MV constraint for an ILR picture may be signaled in the bit stream. PU signaling for the enhancement layer may be signaled in the bit stream. A sequence level flag (e.g., zeroMV_enabled_flag) may indicate whether the proposed zero MV constraint is applied to the enhancement layer when ILR picture is selected for motion compensated prediction. The zero MV constraint signal may facilitate the decoding process. For example, the flag may be used for error concealment. The decoder may correct ILR motion vector, if there are errors in bit streams. A sequence level flag (e.g., changed_pu_signaling_enabled_flag) may be added to the bit stream to indicate whether the proposed PU signaling as illustrated by example in Table 2 or the PU signaling as illustrated by example in Table 1 may be applied in the enhancement layer. The two flags may be applied to a high level parameter set, for example, a video parameter set (VPS), a sequence parameter set (SPS), a picture parameter set (PPS), etc. Table 3 illustrates by example addition of the two flags in the SPS to indicate whether the zero MV constraint and/or the proposed PU signaling is being used at the sequence level.

TABLE 3

Descriptor

seq_parameter_set_rbsp( ) {

| | |
|---|---|
| video_parameter_set_id | u(4) |
| sps_max_sub_layers_minus1 | u(3) |
| sps_temporal_id_nesting_flag | u(1) |
| sps_reserved_zero_bit | u(1) |
| profile_tier_level( 1, sps_max_sub_layers_minus1 ) | |
| seq_parameter_set_id | ue(v) |
| video_parameter_set_id | u(4) |
| ... | |
| if(layer_id > 0) | |
| { | |

| | |
|---|---|
| zeroMV_enabled_flag | u(1) |
| changed_pu_signaling_enabled_flag | u(1) |

}
...

As illustrated in Table 3, layer_id may specify the layer in which the current sequence is located. The range of layer_id may for example be from 0 to the maximum layers allowed by the scalable video system. A flag, e.g., zeroMV_enabled_flag may, for example, indicate that the zero MV constraint is not applied to the enhancement layer identified by the layer_id, when the ILR picture is used as a reference. The zeroMV_enabled_flag may, for example, indicate that the zero MV constraint is applied to the enhancement layer for motion compensated prediction using the ILR picture as a reference.

A flag. e.g., changed_pu_signaling_enabled_flag may, for example, may indicate that the unchanged PU signaling is applied to the current enhancement layer that is identified by layer_id. A flag, e.g., sps_changed_pu_signaling_enabled_flag may, for example, may indicate that the modified PU signaling is applied to the current enhancement layer that is identified by layer_id.

FIG. 6B is a diagram illustrating an example of video encoding method. As illustrated in FIG. 6B, at 6050, may identify a prediction unit (PU) of one of a plurality of enhancement layer pictures. At 6052, the video encoding device may determine whether the PU uses an inter-layer reference picture of the enhancement layer picture as a reference picture. At 6054, the video encoding device may set motion vector information associated with the inter-layer reference picture of enhancement layer to a value indicative of zero motion, e.g., if the PU uses the inter-layer reference picture as a reference picture.

FIG. 6C is a diagram illustrating an example of video decoding method. As illustrated in FIG. 6C, at 6070, a video decoding device may receive a bitstream. The bitstream may comprise a plurality of base layer pictures and a plurality of corresponding enhancement layer pictures. At 6072, the video decoding device may determine whether a PU of one of the received enhancement layer pictures uses an inter-layer reference picture as a reference picture. If the PU uses the inter-layer reference picture as the reference picture, at 6074, the video decoding device may set an enhancement layer motion vector associated with the inter-layer reference picture to a value indicative of zero motion.

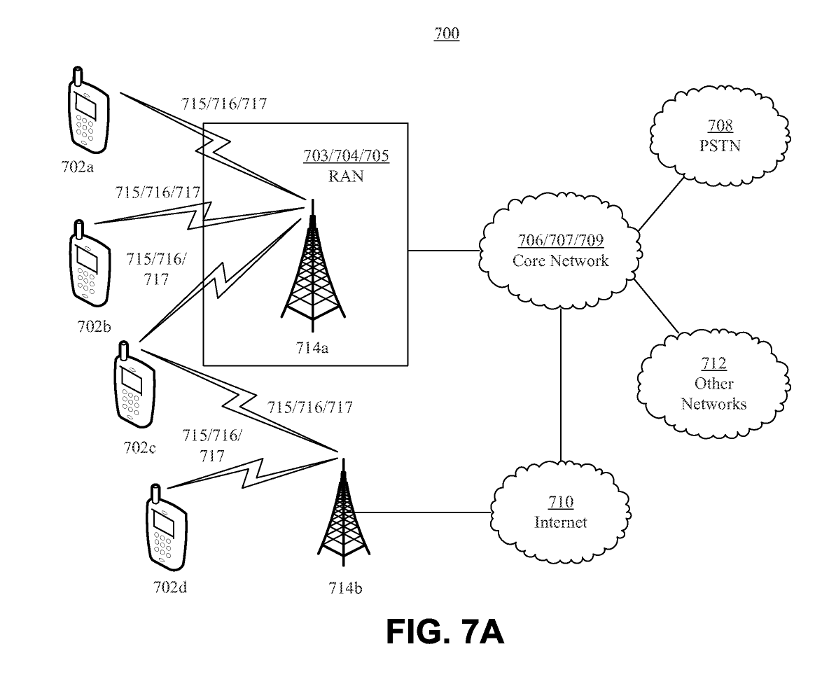

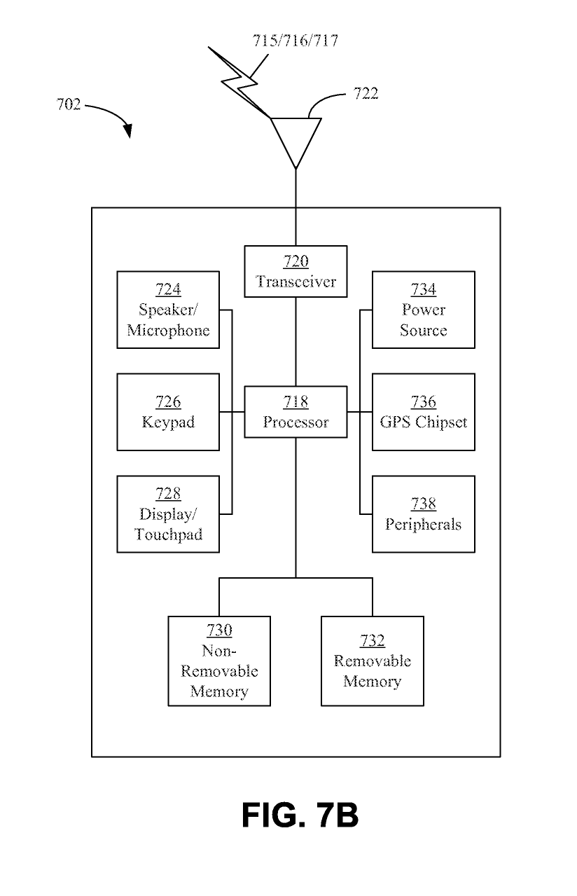

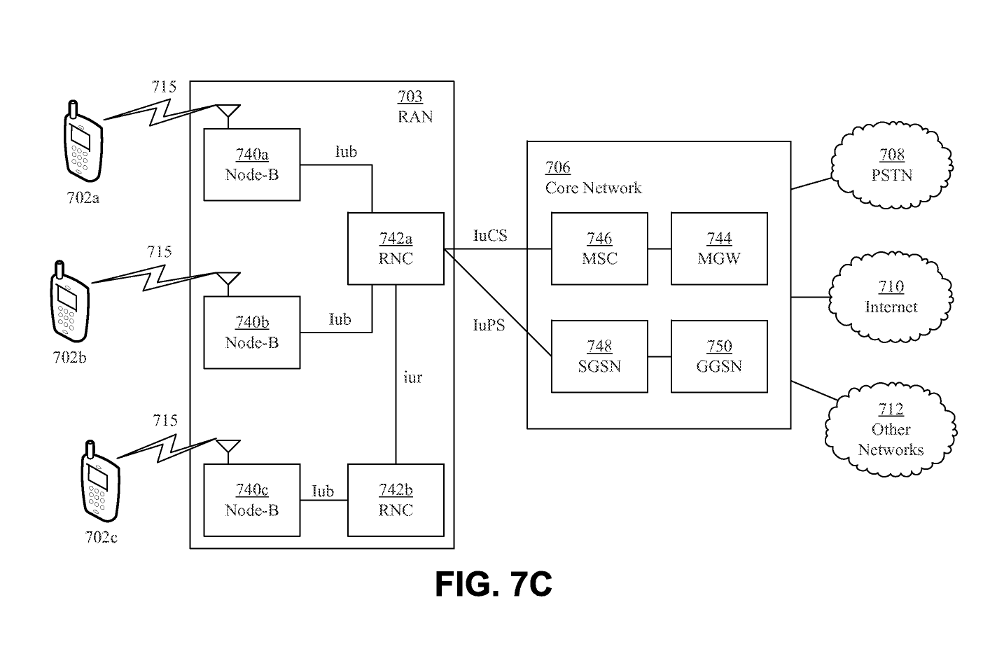

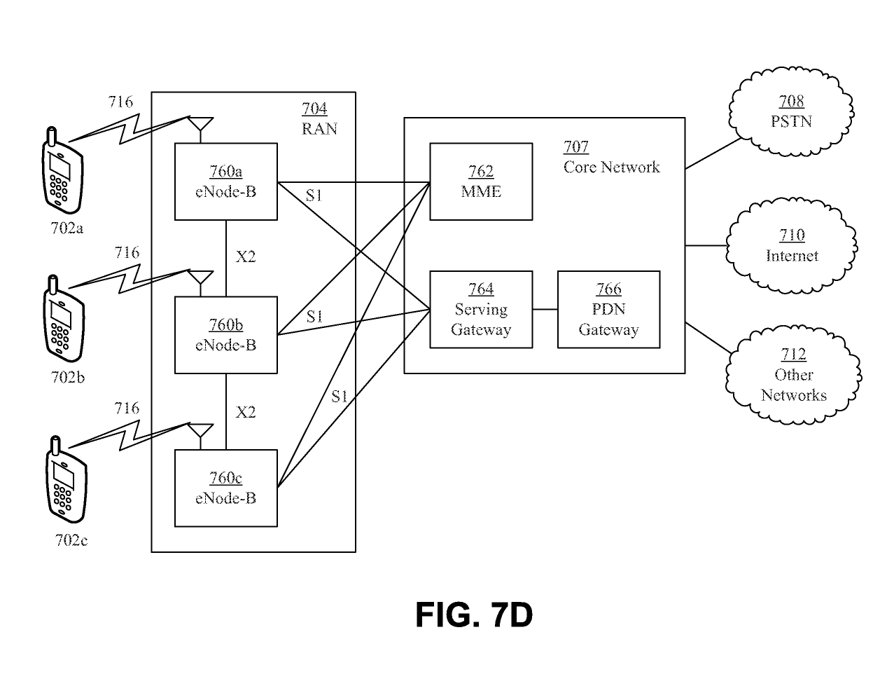

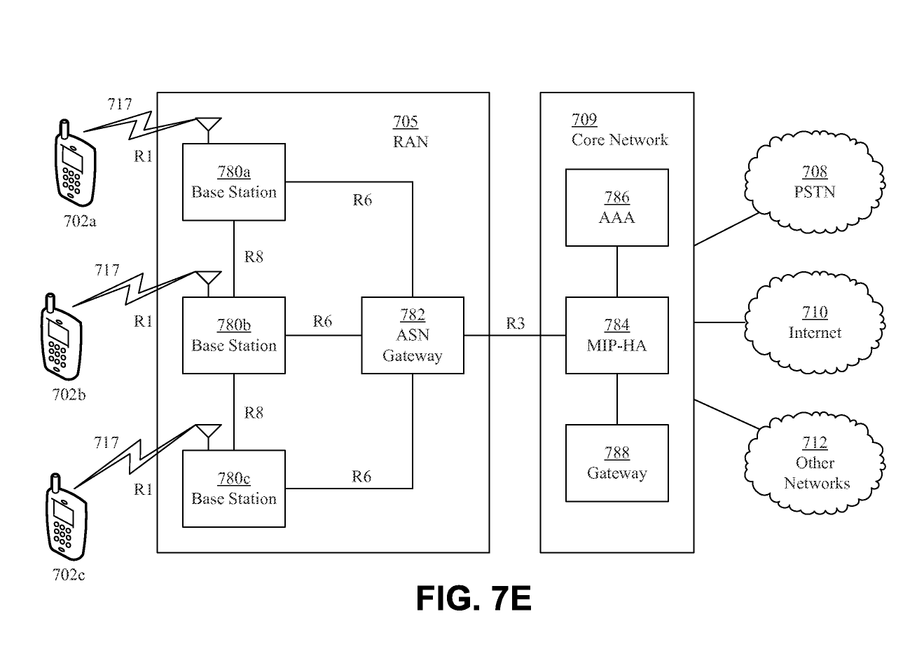

The video coding techniques described herein, for example, employing PU signaling with inter layer zero motion vector constraint, may be implemented in accordance with transporting video in a wireless communication system, such as the example wireless communication system 700, and components thereof, as depicted in FIGS. 7A-7E.

FIG. 7A is a diagram of an example communications system 700 in which one or more disclosed embodiments may be implemented. The communications system 700 may be a multiple access system that provides content, such as voice, data, video, messaging, broadcast, etc., to multiple wireless users. The communications system 700 may enable multiple wireless users to access such content through the sharing of system resources, including wireless bandwidth. For example, the communications system 700 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 7A, the communications system 700 may include wireless transmit/receive units (WTRUs) 702a, 702b, 702c, and/or 702d (which generally or collectively may be referred to as WTRU 702), a radio access network (RAN) 703/704/705, a core network 706/707/709, a public switched telephone network (PSTN) 108, the Internet 710, and other networks 712, though it will be appreciated that the disclosed embodiments contemplate any number of WTRUs, base stations, networks, and/or network elements. Each of the WTRUs 702a, 702b, 702c, 702d may be any type of device configured to operate and/or communicate in a wireless environment. By way of example, the WTRUs 702a. 702b, 702c, 702d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 700 may also include a base station 714a and a base station 714b. Each of the base stations 714a, 714b may be any type of device configured to wirelessly interface with at least one of the WTRUs 702a, 702b, 702c, 702d to facilitate access to one or more communication networks, such as the core network 706/707/709, the Internet 710, and/or the networks 712. By way of example, the base stations 714a, 714b may be a base transceiver station (BTS), a Node-B, an eNode B, a Home Node B, a Home eNode B, a site controller, an access point (AP), a wireless router, and the like. While the base stations 714a, 714b are each depicted as a single element, it will be appreciated that the base stations 714a. 714b may include any number of interconnected base stations and/or network elements.

The base station 714a may be part of the RAN 703/704/705, which may also include other base stations and/or network elements (not shown), such as a base station controller (BSC), a radio network controller (RNC), relay nodes, etc. The base station 714a and/or the base station 714b may be configured to transmit and/or receive wireless signals within a particular geographic region, which may be referred to as a cell (not shown). The cell may further be divided into cell sectors. For example, the cell associated with the base station 714a may be divided into three sectors. Thus, in one embodiment, the base station 714a may include three transceivers. e.g., one for each sector of the cell. In another embodiment, the base station 714a may employ multiple-input multiple output (MIMO) technology and, therefore, may utilize multiple transceivers for each sector of the cell.

The base stations 714a, 714b may communicate with one or more of the WTRUs 702a, 702b, 702c, 702d over an air interface 715/716/717, which may be any suitable wireless communication link (e.g., radio frequency (RF), microwave, infrared (IR), ultraviolet (UV), visible light, etc.). The air interface 715/716/717 may be established using any suitable radio access technology (RAT).

More specifically, as noted above, the communications system 700 may be a multiple access system and may employ one or more channel access schemes, such as CDMA, TDMA, FDMA, OFDMA. SC-FDMA, and the like. For example, the base station 714a in the RAN 703/704/705 and the WTRUs 702a, 702b. 702c may implement a radio technology such as Universal Mobile Telecommunications System (UMTS) Terrestrial Radio Access (UTRA), which may establish the air interface 715/716/717 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 714a and the WTRUs 702a, 702b. 702c may implement a radio technology such as Evolved UMTS Terrestrial Radio Access (E-UTRA), which may establish the air interface 715/716/717 using Long Term Evolution (LTE) and/or LTE-Advanced (LTE-A).

In other embodiments, the base station 714a and the WTRUs 702a, 702b, 702c may implement radio technologies such as IEEE 802.16 (e.g., Worldwide Interoperability for Microwave Access (WiMAX)), CDMA2000, CDMA2000 IX, CDMA2000 EV-DO, Interim Standard 2000 (IS-2000). Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 714b in FIG. 7A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 714b and the WTRUs 702c, 702d may implement a radio technology such as IEEE 802.11 to establish a wireless local area network (WLAN). In another embodiment, the base station 714b and the WTRUs 702c, 702d may implement a radio technology such as IEEE 802.15 to establish a wireless personal area network (WPAN). In yet another embodiment, the base station 714b and the WTRUs 702c. 702d may utilize a cellular-based RAT (e.g., WCDMA, CDMA2000, GSM, LTE, LTE-A, etc.) to establish a picocell or femtocell. As shown in FIG. 7A, the base station 714b may have a direct connection to the Internet 710. Thus, the base station 714b may not be required to access the Internet 710 via the core network 706/707/709.

The RAN 703/704/705 may be in communication with the core network 706/707/709, which may be any type of network configured to provide voice, data, applications, and/or voice over internet protocol (VoIP) services to one or more of the WTRUs 702a, 702b, 702c, 702d. For example, the core network 706/707/709 may provide call control, billing services, mobile location-based services, pre-paid calling, Internet connectivity, video distribution, etc., and/or perform high-level security functions, such as user authentication. Although not shown in FIG. 7A, it will be appreciated that the RAN 703/704/705 and/or the core network 706/707/709 may be in direct or indirect communication with other RANs that employ the same RAT as the RAN 703/704/705 or a different RAT. For example, in addition to being connected to the RAN 703/704/705, which may be utilizing an E-UTRA radio technology, the core network 706/707/709 may also be in communication with another RAN (not shown) employing a GSM radio technology.

The core network 706/707/709 may also serve as a gateway for the WTRUs 702a, 702b, 702c, 702d to access the PSTN 708, the Internet 710, and/or other networks 712. The PSTN 708 may include circuit-switched telephone networks that provide plain old telephone service (POTS). The Internet 710 may include a global system of interconnected computer networks and devices that use common communication protocols, such as the transmission control protocol (TCP), user datagram protocol (UDP) and the internet protocol (IP) in the TCP/IP internet protocol suite. The networks 712 may include wired or wireless communications networks owned and/or operated by other service providers. For example, the networks 712 may include another core network connected to one or more RANs, which may employ the same RAT as the RAN 703/704/705 or a different RAT.

Some or all of the WTRUs 702a. 702b, 702c, 702d in the communications system 700 may include multi-mode capabilities, e.g., the WTRUs 702a, 702b, 702c, 702d may include multiple transceivers for communicating with different wireless networks over different wireless links. For example, the WTRU 702c shown in FIG. 7A may be configured to communicate with the base station 714a, which may employ a cellular-based radio technology, and with the base station 714b, which may employ an IEEE 802 radio technology.

FIG. 7B is a system diagram of an example WTRU 702. As shown in FIG. 7B, the WTRU 702 may include a processor 718, a transceiver 720, a transmit/receive element 722, a speaker/microphone 724, a keypad 726, a display/touchpad 728, non-removable memory 730, removable memory 732, a power source 734, a global positioning system (GPS) chipset 736, and other peripherals 738. It will be appreciated that the WTRU 702 may include any sub-combination of the foregoing elements while remaining consistent with an embodiment. Also, embodiments contemplate that the base stations 714a and 714b, and/or the nodes that base stations 714a and 714b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 7B and described herein.

The processor 718 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

The processor 718 may perform signal coding, data processing, power control, input/output processing, and/or any other functionality that enables the WTRU 702 to operate in a wireless environment. The processor 718 may be coupled to the transceiver 720, which may be coupled to the transmit/receive element 722. While FIG. 7B depicts the processor 718 and the transceiver 720 as separate components, it will be appreciated that the processor 718 and the transceiver 720 may be integrated together in an electronic package or chip. The transmit/receive element 722 may be configured to transmit signals to, or receive signals from, a base station (e.g., the base station 714a) over the air interface 715/716/717. For example, in one embodiment, the transmit/receive element 722 may be an antenna configured to transmit and/or receive RF signals. In another embodiment, the transmit/receive element 722 may be an emitter/detector configured to transmit and/or receive IR, UV, or visible light signals, for example. In yet another embodiment, the transmit/receive element 722 may be configured to transmit and receive both RF and light signals. It will be appreciated that the transmit/receive element 722 may be configured to transmit and/or receive any combination of wireless signals.

In addition, although the transmit/receive element 722 is depicted in FIG. 7B as a single element, the WTRU 702 may include any number of transmit/receive elements 722. More specifically, the WTRU 702 may employ MIMO technology. Thus, in one embodiment, the WTRU 702 may include two or more transmit/receive elements 722 (e.g., multiple antennas) for transmitting and receiving wireless signals over the air interface 715/716/717.

The transceiver 720 may be configured to modulate the signals that are to be transmitted by the transmit/receive element 722 and to demodulate the signals that are received by the transmit/receive element 722. As noted above, the WTRU 702 may have multi-mode capabilities. Thus, the transceiver 720 may include multiple transceivers for enabling the WTRU 702 to communicate via multiple RATs, such as UTRA and IEEE 802.11, for example.

The processor 718 of the WTRU 702 may be coupled to, and may receive user input data from, the speaker/microphone 724, the keypad 726, and/or the display/touchpad 728 (e.g., a liquid crystal display (LCD) display unit or organic light-emitting diode (OLED) display unit). The processor 718 may also output user data to the speaker/microphone 724, the keypad 726, and/or the display/touchpad 728. In addition, the processor 718 may access information from, and store data in, any type of suitable memory, such as the non-removable memory 730 and/or the removable memory 732. The non-removable memory 730 may include random-access memory (RAM), read-only memory (ROM), a hard disk, or any other type of memory storage device. The removable memory 732 may include a subscriber identity module (SIM) card, a memory stick, a secure digital (SD) memory card, and the like. In other embodiments, the processor 718 may access information from, and store data in, memory that is not physically located on the WTRU 702, such as on a server or a home computer (not shown).

The processor 718 may receive power from the power source 734, and may be configured to distribute and/or control the power to the other components in the WTRU 702. The power source 734 may be any suitable device for powering the WTRU 702. For example, the power source 734 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 718 may also be coupled to the GPS chipset 736, which may be configured to provide location information (e.g., longitude and latitude) regarding the current location of the WTRU 702. In addition to, or in lieu of, the information from the GPS chipset 736, the WTRU 702 may receive location information over the air interface 715/716/717 from a base station (e.g., base stations 714a, 714b) and/or determine its location based on the timing of the signals being received from two or more nearby base stations. It will be appreciated that the WTRU 702 may acquire location information by way of any suitable location-determination implementation while remaining consistent with an embodiment.

The processor 718 may further be coupled to other peripherals 738, which may include one or more software and/or hardware modules that provide additional features, functionality and/or wired or wireless connectivity. For example, the peripherals 738 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 7C is a system diagram of the RAN 703 and the core network 706 according to an embodiment. As noted above, the RAN 703 may employ a UTRA radio technology to communicate with the WTRUs 702a, 702b, 702c over the air interface 715. The RAN 703 may also be in communication with the core network 706. As shown in FIG. 7C, the RAN 703 may include Node-Bs 740a, 740b, 740c, which may each include one or more transceivers for communicating with the WTRUs 702a, 702b, 702c over the air interface 715. The Node-Bs 740a, 740b, 740c may each be associated with a particular cell (not shown) within the RAN 703. The RAN 703 may also include RNCs 742a, 742b. It will be appreciated that the RAN 703 may include any number of Node-Bs and RNCs while remaining consistent with an embodiment.

As shown in FIG. 7C, the Node-Bs 740a, 740b may be in communication with the RNC 742a. Additionally, the Node-B 740c may be in communication with the RNC 742b. The Node-Bs 740a, 740b, 740c may communicate with the respective RNCs 742a, 742b via an Iub interface. The RNCs 742a, 742b may be in communication with one another via an Iur interface. Each of the RNCs 742a, 742b may be configured to control the respective Node-Bs 740a, 740b, 740c to which it is connected. In addition, each of the RNCs 742a, 742b may be configured to carry out or support other functionality, such as outer loop power control, load control, admission control, packet scheduling, handover control, macrodiversity, security functions, data encryption, and the like.

The core network 706 shown in FIG. 7C may include a media gateway (MGW) 744, a mobile switching center (MSC) 746, a serving GPRS support node (SGSN) 748, and/or a gateway GPRS support node (GGSN) 750. While each of the foregoing elements are depicted as part of the core network 706, it will be appreciated that any one of these elements may be owned and/or operated by an entity other than the core network operator.

The RNC 742a in the RAN 703 may be connected to the MSC 746 in the core network 706 via an IuCS interface. The MSC 746 may be connected to the MGW 744. The MSC 746 and the MGW 744 may provide the WTRUs 702a, 702b, 702c with access to circuit-switched networks, such as the PSTN 708, to facilitate communications between the WTRUs 702a, 702b, 702c and traditional land-line communications devices.

The RNC 742a in the RAN 703 may also be connected to the SGSN 748 in the core network 706 via an IuPS interface. The SGSN 748 may be connected to the GGSN 750. The SGSN 748 and the GGSN 750 may provide the WTRUs 702a. 702b, 702c with access to packet-switched networks, such as the Internet 710, to facilitate communications between and the WTRUs 702a, 702b, 702c and IP-enabled devices.

As noted above, the core network 706 may also be connected to the networks 712, which may include other wired or wireless networks that are owned and/or operated by other service providers.

FIG. 7D is a system diagram of the RAN 704 and the core network 707 according to an embodiment. As noted above, the RAN 704 may employ an E-UTRA radio technology to communicate with the WTRUs 702a, 702b, 702c over the air interface 716. The RAN 704 may also be in communication with the core network 707.

The RAN 704 may include eNode-Bs 760a, 760b, 760c, though it will be appreciated that the RAN 704 may include any number of eNode-Bs while remaining consistent with an embodiment. The eNode-Bs 760a, 760b, 760c may each include one or more transceivers for communicating with the WTRUs 702a, 702b, 702c over the air interface 716. In one embodiment, the eNode-Bs 760a, 760b, 760c may implement MIMO technology. Thus, the eNode-B 760a, for example, may use multiple antennas to transmit wireless signals to, and receive wireless signals from, the WTRU 702a.

Each of the eNode-Bs 760a, 760b, 760c may be associated with a particular cell (not shown) and may be configured to handle radio resource management decisions, handover decisions, scheduling of users in the uplink and/or downlink, and the like. As shown in FIG. 7D, the eNode-Bs 760a, 760b, 760c may communicate with one another over an X2 interface.

The core network 707 shown in FIG. 7D may include a mobility management gateway (MME) 762, a serving gateway 764, and a packet data network (PDN) gateway 766. While each of the foregoing elements are depicted as part of the core network 707, it will be appreciated that any one of these elements may be owned and/or operated by an entity other than the core network operator.

The MME 762 may be connected to each of the eNode-Bs 760a, 760b, 760c in the RAN 704 via an S1 interface and may serve as a control node. For example, the MME 762 may be responsible for authenticating users of the WTRUs 702a, 702b, 702c, bearer activation/deactivation, selecting a particular serving gateway during an initial attach of the WTRUs 702a, 702b, 702c, and the like. The MME 762 may also provide a control plane function for switching between the RAN 704 and other RANs (not shown) that employ other radio technologies, such as GSM or WCDMA.

The serving gateway 764 may be connected to each of the eNode-Bs 760a, 760b, 760c in the RAN 704 via the S1 interface. The serving gateway 764 may generally route and forward user data packets to/from the WTRUs 702a, 702b, 702c. The serving gateway 764 may also perform other functions, such as anchoring user planes during inter-eNode B handovers, triggering paging when downlink data is available for the WTRUs 702a, 702b, 702c, managing and storing contexts of the WTRUs 702a, 702b, 702c, and the like.

The serving gateway 764 may also be connected to the PDN gateway 766, which may provide the WTRUs 702a, 702b, 702c with access to packet-switched networks, such as the Internet 710, to facilitate communications between the WTRUs 702a, 702b, 702c and IP-enabled devices.

The core network 707 may facilitate communications with other networks. For example, the core network 707 may provide the WTRUs 702a. 702b, 702c with access to circuit-switched networks, such as the PSTN 708, to facilitate communications between the WTRUs 702a, 702b, 702c and traditional land-line communications devices. For example, the core network 707 may include, or may communicate with, an IP gateway (e.g., an IP multimedia subsystem (IMS) server) that serves as an interface between the core network 707 and the PSTN 708. In addition, the core network 707 may provide the WTRUs 702a, 702b, 702c with access to the networks 712, which may include other wired or wireless networks that are owned and/or operated by other service providers.

FIG. 7E is a system diagram of the RAN 705 and the core network 709 according to an embodiment. The RAN 705 may be an access service network (ASN) that employs IEEE 802.16 radio technology to communicate with the WTRUs 702a, 702b, 702c over the air interface 717. As will be further discussed below, the communication links between the different functional entities of the WTRUs 702a, 702b, 702c, the RAN 705, and the core network 709 may be defined as reference points.

As shown in FIG. 7E, the RAN 705 may include base stations 780a, 780b, 780c, and an ASN gateway 782, though it will be appreciated that the RAN 705 may include any number of base stations and ASN gateways while remaining consistent with an embodiment. The base stations 780a, 780b, 780c may each be associated with a particular cell (not shown) in the RAN 705 and may each include one or more transceivers for communicating with the WTRUs 702a, 702b, 702c over the air interface 717. In one embodiment, the base stations 780a, 780b. 780c may implement MIMO technology. Thus, the base station 780a, for example, may use multiple antennas to transmit wireless signals to, and receive wireless signals from, the WTRU 702a. The base stations 780a, 780b. 780c may also provide mobility management functions, such as handoff triggering, tunnel establishment, radio resource management, traffic classification, quality of service (QoS) policy enforcement, and the like. The ASN gateway 782 may serve as a traffic aggregation point and may be responsible for paging, caching of subscriber profiles, routing to the core network 709, and the like.

The air interface 717 between the WTRUs 702a, 702b, 702c and the RAN 705 may be defined as an R1 reference point that implements the IEEE 802.16 specification. In addition, each of the WTRUs 702a, 702b, 702c may establish a logical interface (not shown) with the core network 709. The logical interface between the WTRUs 702a, 702b, 702c and the core network 709 may be defined as an R2 reference point, which may be used for authentication, authorization, IP host configuration management, and/or mobility management.

The communication link between each of the base stations 780a, 780b, 780c may be defined as an R8 reference point that includes protocols for facilitating WTRU handovers and the transfer of data between base stations. The communication link between the base stations 780a, 780b, 780c and the ASN gateway 782 may be defined as an R6 reference point. The R6 reference point may include protocols for facilitating mobility management based on mobility events associated with each of the WTRUs 702a, 702b, 702c.

As shown in FIG. 7E, the RAN 705 may be connected to the core network 709. The communication link between the RAN 705 and the core network 709 may defined as an R3 reference point that includes protocols for facilitating data transfer and mobility management capabilities, for example. The core network 709 may include a mobile IP home agent (MIP-HA) 784, an authentication, authorization, accounting (AAA) server 786, and a gateway 788. While each of the foregoing elements are depicted as part of the core network 709, it will be appreciated that any one of these elements may be owned and/or operated by an entity other than the core network operator.

The MIP-HA may be responsible for IP address management, and may enable the WTRUs 702a, 702b, 702c to roam between different ASNs and/or different core networks. The MIP-HA 784 may provide the WTRUs 702a, 702b, 702c with access to packet-switched networks, such as the Internet 710, to facilitate communications between the WTRUs 702a, 702b, 702c and IP-enabled devices. The AAA server 786 may be responsible for user authentication and for supporting user services. The gateway 788 may facilitate interworking with other networks. For example, the gateway 788 may provide the WTRUs 702a, 702b, 702c with access to circuit-switched networks, such as the PSTN 708, to facilitate communications between the WTRUs 702a, 702b, 702c and traditional land-line communications devices. In addition, the gateway 788 may provide the WTRUs 702a, 702b, 702c with access to the networks 712, which may include other wired or wireless networks that are owned and/or operated by other service providers.

Although not shown in FIG. 7E, it will be appreciated that the RAN 705 may be connected to other ASNs and the core network 709 may be connected to other core networks. The communication link between the RAN 705 the other ASNs may be defined as an R4 reference point, which may include protocols for coordinating the mobility of the WTRUs 702a, 702b, 702c between the RAN 705 and the other ASNs. The communication link between the core network 709 and the other core networks may be defined as an R5 reference, which may include protocols for facilitating interworking between home core networks and visited core networks.

The processes and instrumentalities described herein may apply in any combination, may apply to other wireless technology, and for other services. The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1.-26. (canceled)

27. A video encoding method comprising:
generating a video bitstream comprising a plurality of base layer pictures and a plurality of corresponding enhancement layer pictures;
identifying a prediction unit (PU) of one of the enhancement layer pictures;
determining whether the PU uses an inter-layer reference picture of the enhancement layer picture as a reference picture; and
on a condition that the PU uses the inter-layer reference picture as the reference picture,
setting motion vector information associated with the inter-layer reference picture of enhancement layer to a value indicative of zero motion, and
sending the motion vector information, associated with the inter-layer picture reference of the enhancement layer, indicative of zero motion.

28. The method of claim 27, wherein the motion vector information associated with the inter-layer reference picture of enhancement layer comprises one or more of a motion vector predictor (MVP), or a motion vector difference (MVD).

29. The method of claim 27, wherein the enhancement layer picture is associated with an enhancement layer and the inter-layer reference picture is derived from a collocated base layer picture.

30. The method of claim 27, wherein the inter-layer reference picture is associated with a reference picture list of an enhancement layer.

31. The method of claim 27, wherein the inter-layer reference picture is stored in a decoded picture buffer (DPB) of enhancement layer.

32. The method of claim 27, wherein the motion vector information associated with the inter-layer reference picture of enhancement layer comprises one or more motion vectors, and wherein the motion vectors are associated with the PU.

33. The method of claim 32, wherein each of the motion vectors is set to a value 0.

34. The method of claim 27, further comprising:
on a condition that the PU uses the inter-layer reference picture as the reference picture, disabling the use of the inter-layer reference picture for bi-prediction of the PU of the enhancement layer picture.

35. The method of claim 34, on a condition that the PU uses the inter-layer reference picture as the reference picture, performing motion prediction using uni-prediction.

36. A video decoding method comprising:
receiving a video bitstream comprising a plurality of base layer pictures and a plurality of enhancement layer pictures; and
on a condition that a prediction unit (PU) of the one of the enhancement layer pictures makes reference to an inter-layer reference picture as a reference picture for motion prediction,
receiving an enhancement layer motion vector information, associated with an inter-layer picture, indicative of zero motion, and
setting the enhancement layer motion vector information associated with the inter-layer reference picture to a value indicative of zero motion.

37. A video encoding device comprising:
a processor configured to:
generate a video bitstream comprising a plurality of base layer pictures and a plurality of corresponding enhancement layer pictures;
identify a prediction unit (PU) of one of the enhancement layer pictures;
determine whether the PU uses an inter-layer reference picture of the enhancement layer picture as a reference picture; and
on a condition that the PU uses the inter-layer reference picture as the reference picture,
set motion vector information associated with the inter-layer reference picture of enhancement layer to a value indicative of zero motion, and
send the motion vector information, associated with the inter-layer reference picture of the enhancement layer, indicative of zero motion.

38. The video encoding device of claim 37, wherein the motion vector information associated with the inter-layer reference picture of enhancement layer comprises one or more of a motion vector predictor (MVP), or a motion vector difference (MVD).

39. The video encoding device of claim 37, wherein the enhancement layer picture is associated with an enhancement layer and the inter-layer reference picture is derived from a collocated base layer picture.

40. The video encoding device of claim 37, wherein the inter-layer reference picture is associated with a reference picture list of enhancement layer.

41. The video encoding device of claim 37, wherein the inter-layer reference picture is stored in a decoded picture buffer (DPB) of enhancement layer.

42. The video encoding device of claim 37, wherein the motion vector information associated with the inter-layer reference picture of enhancement layer comprises one or more motion vectors, and wherein the motion vectors are associated with the PU.

43. The video encoding device of claim 42, wherein each of the motion vectors is set to a value 0.

44. The video encoding device of claim 37, wherein the processor is further configured to:
on a condition that the PU uses the inter-layer reference picture as the reference picture, disable the use of the inter-layer reference picture for bi-prediction of the enhancement layer picture.

45. The video encoding device of claim 44, wherein the processor is further configured to:
on a condition that the PU uses the inter-layer reference picture as the reference picture, perform motion prediction using uni-prediction.

46. A video decoding device comprising:
a processor configured to:
receive a video bitstream comprising a plurality of base layer pictures and a plurality of enhancement layer pictures; and
on a condition that a prediction unit (PU) of the one of the enhancement layer pictures makes reference to an inter-layer reference picture for motion prediction,
receive an enhancement layer motion vector information, associated with the inter-layer reference picture, indicative of zero motion, and
set the enhancement layer motion vector information associated with the inter-layer reference picture to a value indicative of zero motion.
